(19) United States
(12) Patent Application Publication
(10) Pub. No.: US 2002/0173981 A1
(43) Pub. Date: Nov. 21, 2002

(54) Domain place registration system and method for registering for geographic based services

(76) Inventor: Brett B. Stewart, Austin, TX (US)

Correspondence Address: Jeffrey C. Hood, Conley, Rose, & Tayon, P.C., P.O. Box 398, Austin, TX, 78767, US

(21) Appl. No.: 09/861,201

(22) Filed: May 18, 2001

(51) Int. Cl. G06F 17/60

(52) U.S. Cl. 705/1; 705/14

(57) ABSTRACT

System and method for enabling a business to register a domain location to provide location based services to on-site customers. The system includes a network, an access point coupled to the network, and a memory medium storing a registry comprising domain location entries, each comprising a domain name and geographic location of the business. The registry is accessible through the network via the at least one access point, and is useable in creating geographic based web content for one or more businesses. The system includes a memory medium which stores a registration system, such as a registration web site accessible by the business, and is operable to receive business registration information from the business and register the business in the registry. The web site content for the business is accessible by an on-site customer of the business via a personal computing device, whereby location based services are provided.

### BACKGROUND OF THE INVENTION

1. Field of the Invention

This invention relates generally to network communications, and more specifically to a system and method enabling a business to register a domain location to provide location based information and services to on-site users.

2. Description of the Relevant Art

Various types of wired and wireless infrastructures are being developed to service users of computing devices, such as personal computing devices (PCDs). Currently, numerous service providers are attempting to install wired and/or wireless network infrastructures in various locations, such as airports, hotels, office buildings, shopping malls, stores, etc. for use by various users, such as mobile users (MUs) of PCDs. Increasingly, many shop and restaurant proprietors provide on-site Internet access to their customers as a free service or for charge by providing a DSL link, for example, and hosting an access point (AP) on the premises. Many of these businesses have associated web sites which are accessible by their customers through the AP to send or receive information, place orders for products or services, etc.

However, the information available on these web sites is typically aimed at a national audience or clientele, i.e., the particular location of the business establishment and customer has little or no bearing on the content of the web site. Further, the provider developing content for the web site may have little knowledge of which nearby business establishments also host wireless access points and provide geographic-based services. This limits the ability for neighboring businesses to cross-advertise and cross-sell their services.

Therefore, it would be desirable to provide a system and method which enables a business to register a domain location to provide known geographic location (KGL) dependent information and/or services to the business and its off-site and on-site customers. It would be further desirable to provide for the registration of domain locations and KGL services independent of the particular network service provider used. It would be further desirable for the domain place registration information to be accessible for use in developing web site content.

### SUMMARY OF THE INVENTION

Various embodiments of a system and method for domain place registration are presented. The domain place registration method may be used in a network system. The network system may include one or more access points (APs) coupled to a network. The network access points may include wireless access points, and may also include wired access points. Access points for the network may be distributed in various facilities, such as airports, mass-transit stations, hotels, and various businesses, such as business offices, waiting rooms, restaurants, and stores. The network may couple to a wide area network, such as the Internet. A service provider (SP) or network provider may provide network services, such as Internet access and/or infomediation services, over the network infrastructure.

The system may include a domain place registry where physical domain location information is stored. In one embodiment, the system may include a domain place registration web site which a business may access to register a domain location and to specify desirable KGL services and/or infomediation services to be available at the location. The domain place registration web site may be hosted on a server computer system coupled to the network, for example, through the Internet.

In one embodiment, the method may include receiving business registration information of a business, including location information of the business, and registering a domain location of the business in the registry in response to the received business registration information. In one embodiment, receiving business registration information may comprise accessing a registration web site. As noted above, the business may also specify desired KGL and/or infomediation services. Example business or infomediary services include: 1) whether users should pay for Internet access; 2) what demographic information, if any, should be queried from the user; 3) what advertisements or coupons should be provided to the user, e.g., based on demographic information, past purchases or number of visits; 4) whether each user's Internet usage should be tracked; 6) whether the user's browsing of the business website should be tracked; and/or 7) whether purchases should be tracked. These KGL and/or infomediation services may be implemented by a server associated with the domain place registry, or a server associated with the domain place registry may use this information to automatically configure the business web site accordingly.

The registry may also be generally useable in creating geographic based web site content for one or more businesses. For example, a business may access the registry to determine one or more neighboring businesses which are present in the registry. Web site content may then be generated for the business, wherein the web site content includes one or more references to the one or more neighboring businesses which are present in the registry. In one embodiment, when the registry is accessed to determine one or more neighboring businesses which are present in the registry, a map may be displayed which shows the location of the business and locations of the one or more neighboring businesses which are present in the registry. In one embodiment, businesses located in the same area may use the registry to become aware of each other, and then may negotiate or contract to provide advertisements or incentives to each other's customers to encourage cross-selling or cross-advertising. As a result, a customer accessing the business's web site may be presented with discounts or specials for goods or services in nearby businesses. Businesses may also use the domain place registry to specify or implement infomediary services, such as tracking user demographic information, including purchasing habits, frequency of visits, memberships, etc. and use this information to provide more personalized services to customers.

In one embodiment, the business may include an access point for accessing the web site. The method may further include a customer accessing the web site through the access point, followed by provision of known geographic location (KGL) services and/or infomediation services to the customer through the web site.

In one embodiment, a user may access the network system through a personal computing device (PCD) using, for example, a wireless network interface. When in sufficiently close range to an access point, the PCD may wirelessly communicate with the AP in the network system. In one embodiment, the APs are arranged at known geographic locations and may provide geographic location information regarding the geographic location of the AP or the mobile user. In other words, if the AP knows its own location, and if the user is on-site, the AP may assume that the user shares the location during the connection, and transmit the location information to the system. Alternately, the location of the user may be determined, for example, by a Global Positioning System (GPS) comprised in the user's PCD. The PCD may transmit the GPS information to the AP upon connection. In one embodiment, the user may access the network system through a wireless telephone, such as a cellular telephone. The cellular telephone may include a GPS, and may transmit location information to a web-server via cellular transmission tower.

The KGL services provided to the customer may include coupons, discounts, advertisements, geographic or merchant maps of the area local to the business, weather information for the area, maps of parks, museums, or events in the area, locations of nearby service providers, such as banks, ATMs, etc., among others. In one embodiment, the system may include time-of-access information to provide time-dependent KGL services to the customer.

In one embodiment, each PCD may store identification information which may uniquely identify the user. The identification information may take various forms, such as a digital certificate, a System ID (SID), MAC ID, or other identification which may be used to identify the user. As used herein, the SID may comprise an SSID (Service Set ID) or an ESSID (Extended Service Set ID). When the PCD becomes close to an access point, the PCD may provide the identification information to the access point, which may transmit the identification information to the business's web site.

When the system (e.g. the web site) receives the identification information from a PCD of a user, the system may determine the identity of the user, and may use the identification information to provide personalized KGL services to the user. In other words, the services or information provided to the user may be based on the user's known geographic location as well as demographic or past transaction information of the user. For example, the system may determine whether the user is a repeat customer, and if so, may provide customized information, such as discounts or promotions, to the user based upon historical records. In one embodiment, the system may include a memory medium which stores a list of user identification information and associated KGL information.

Thus the system and method described herein enables a business to register domain location information with a domain place registry. The business may also register KGL-based and infomediation services that may be implemented on or for the business web site. The domain location information may be used to provide location dependent information on a web site for on-site users or customers, and provides a number of advantages over the prior art.

### BRIEF DESCRIPTION OF THE DRAWINGS

Other objects and advantages of the invention will become apparent upon reading the following detailed description and upon reference to the accompanying drawings in which:

FIG. 1A is a block diagram of one embodiment of a network system suitable to implement the present invention;

FIG. 1B is a block diagram of another embodiment of a network system suitable to implement the present invention;

FIG. 2 is a flowchart of a KGL service registration process, according to one embodiment;

FIG. 3 is a flowchart of business use of the domain place registry, according to one embodiment; and

FIG. 4 is a flowchart of a KGL service process, according to one embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE EMBODIMENTS

Incorporation by Reference

U.S. Pat. No. 5,835,061 titled “Method and Apparatus for Geographic-Based Communications Service”, whose inventor is Brett B. Stewart, is hereby incorporated by reference in its entirety as though fully and completely set forth herein.

U.S. Pat. No. 5,969,678 titled “System for Hybrid Wired and Wireless Geographic-Based Communications Service”, whose inventor is Brett B. Stewart, is hereby incorporated by reference in its entirety as though fully and completely set forth herein.

U.S. patent application Ser. No. 09/433,817 titled “Geographic Based Communications Service” and filed on Nov. 3, 1999, whose inventors are Brett B. Stewart and James Thompson, is hereby incorporated by reference in its entirety as though fully and completely set forth herein.

U.S. patent application Ser. No. 09/551,309 titled “System and Method for Managing User Demographic Information Using Digital Certificates” and filed on Apr. 18, 2000, whose inventors are Brett B. Stewart and James W. Thompson, is hereby incorporated by reference in its entirety as though fully and completely set forth herein.

U.S. patent application Ser. No. 09/433,818 titled “A Network Communication Service with an Improved Subscriber Model Using Digital Certificates” and filed on Nov. 3, 1999, whose inventors are Brett B. Stewart and James W. Thompson, is hereby incorporated by reference in its entirety as though fully and completely set forth herein.

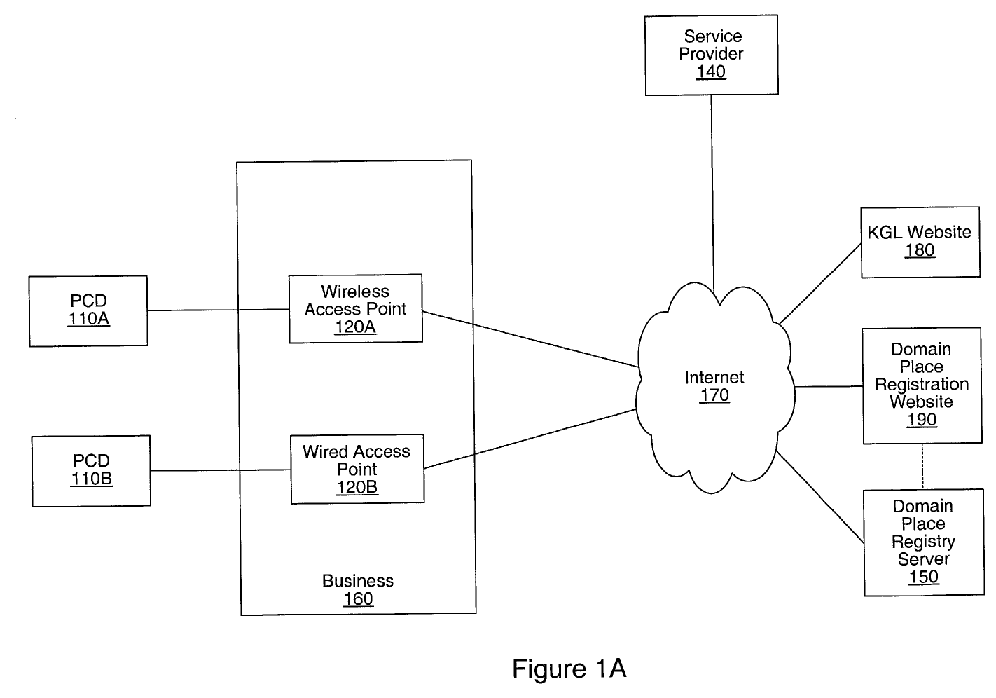

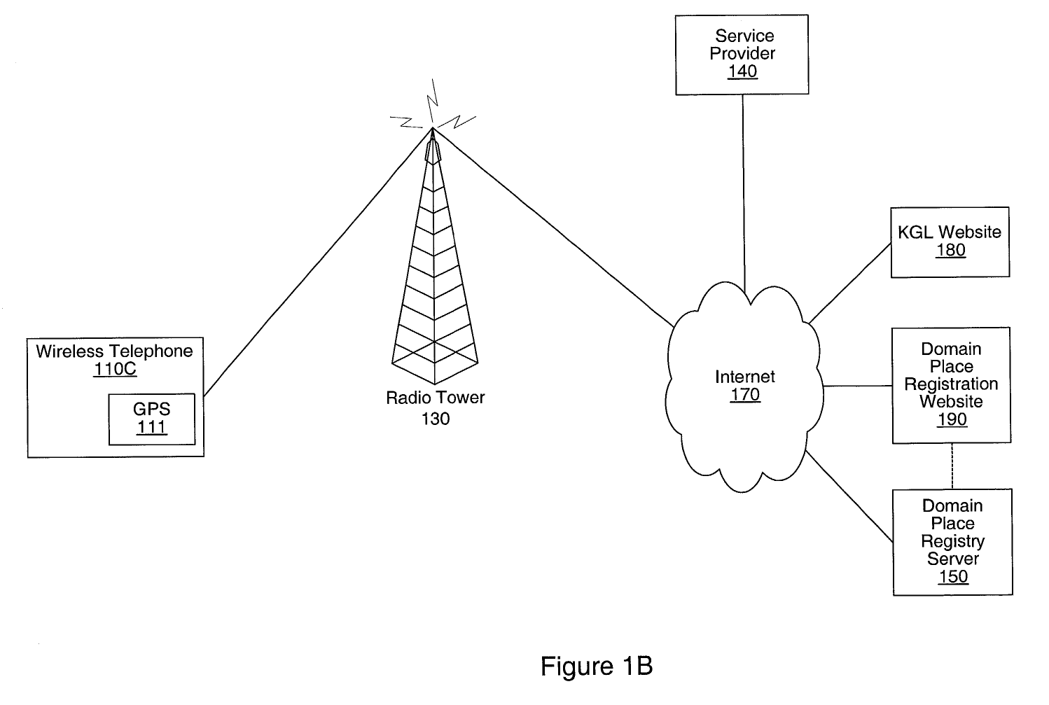

FIG. 1A—Network Communication System with Access Points

FIG. 1A shows one embodiment of a distributed network communication system 100 which may be suitable for implementing various embodiments of the present invention. The network system 100 may include one or more access points 120, such as wireless access point (AP) 120A located at a business 160, which may be operable to communicate with a personal computing device (PCD) 110A in a wireless fashion. The wireless AP 120A may have a wireless connection or transceiver (e.g., an antenna) and may operate according to various wireless standards, such as wireless Ethernet (IEEE 802.11), Bluetooth, etc. One or more of the access points 120 may also be wired access points, such as wired AP 120B, which may be operable to communicate with a personal computing device 110B in a wired fashion.

Each AP 120 may be coupled to a network, such as the Internet 170. The network 170 may comprise a wired network, a wireless network or a combination of wired and wireless networks. For example, the network 170 may include a standard “wired” Ethernet network which connects each of the wireless (and wired) access points 120 together. The network 170 may also include a wireless network based on IEEE 802.11. The network 170 may also include or be coupled to other types of communications networks, (e.g., networks other than those comprised in the Internet) such as the public switched telephone network (PSTN), whereby a user using PCD 110 may send and receive information from/to the PSTN or other communication network through a wireless service provider. The network 170 may also include, or be coupled to, another wide area network, such as a proprietary WAN. The network 170 thus may be, or be coupled to, any of various wide area networks (WANs) or local area networks (WANs), including the Internet 170.

The access points (APs) 120 may be widely distributed in various facilities 160, such as airports, mass-transit stations, hotels, shopping malls, restaurants, hospitals, waiting rooms, and other businesses, such as business offices, law firm offices, retail stores, etc. For example, where the access points 120 are distributed in an airport, one or more access points 120 may be distributed throughout various terminals in the airport, in an airline club, and in coffee shops, restaurants or rental car counters at the respective airport. The access points 120 may thus be primarily designed to service mobile users, wherein it may not be known ahead of time which mobile users will be accessing the network from which locations. Thus the network system 100 is preferably a distributed network system, with access points 120 placed in locations to service mobile users. This differs from a conventional fixed LAN, where it is generally pre-configured as to which pre-determined users will be using which nodes in the fixed LAN on a day-to-day basis.

Each access point 120 may comprise information used to enable network access through a service provider 140, such as a wireless services provider. In one embodiment, each access point 120 may further comprise information used to provide known geographic location (KGL) based services and/or infomediation services to on-site customers.

When in sufficiently close range to an access point 120, or when the PCD 110 is directly coupled to an access point 120B in a wired fashion, the PCD 110 may access the network, e.g., may access a web site with KGL and/or infomediation services 180, described in more detail below. In various embodiments, the KGL web site 180 may be comprised on a web server located on the business premises, on a web server located remotely from the business premises, or on one or more of the APs 120 located on the business premises.

In one embodiment, the system may include a domain place registry server 150 which may be operable to host a domain place registry. The domain place registry may store KGL information and/or infomediation information for a plurality of businesses, i.e., the registry may store the physical locations of businesses or business domains, as well as other business information. This business information, e.g., the KGL information and/or infomediation information may be specified by the business during the registration process. A web site, such as the web site of the business may then be configured to provide these KGL and/or infomediary services.

The KGL and/or infomediation information (or registry information) may be accessed to develop web sites or applications utilizing KGL services. For example, a registered business may develop (or have a third party develop) a business web site 180, referred to herein as a KGL web site 180, to provide KGL services to on-site customers of the business. In one embodiment, the registry information may be used to analyze geographical business issues, such as coffee shop density in an area, etc. In one embodiment, the registry information may be accessible to registered users via a domain place registry web site.

In one embodiment, the domain place registry may include a data structure, such as a table comprising a list of identification information and a corresponding list of known geographic locations (KGLs). In one embodiment, the domain place registry may store the registry information in a spatially coherent manner, such that domain places which are physically near are also near in the registry structure, thus providing for efficient search and analysis strategies. The data structure may also store KGL service information, which may comprise registration information for business subscribers to the KGL service, including billing information. In one embodiment, the data structure may also store customer specific information and/or infomediary information for use in providing KGL services. Thus, the data structure may comprise business subscriber information, as well as customer information. In the preferred embodiment, the domain place registry may be stored on the domain place registry server 150. In an alternate embodiment, as noted above, the data structures which store this information may be comprised in each of the access points 120, or may be provided in various other locations.

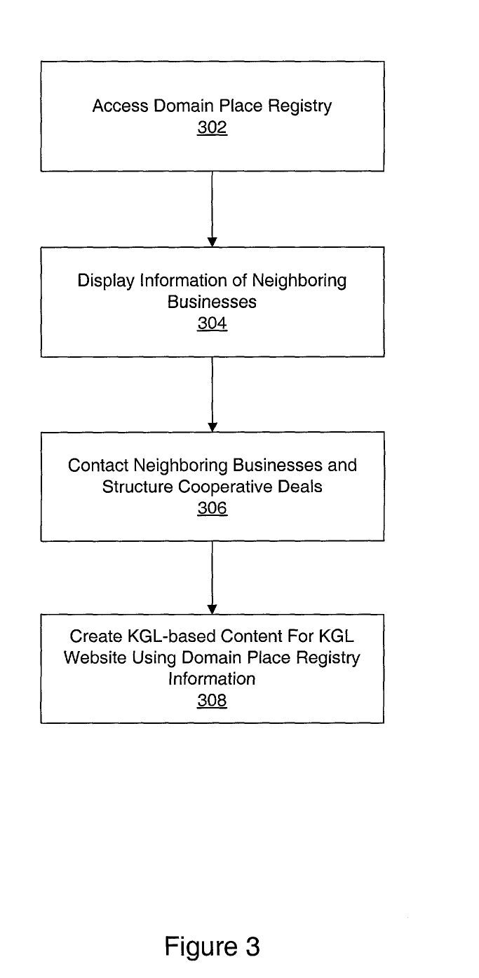

In one embodiment, domain place registration may be performed through a domain place registration web site 190 accessible to the business over the network 170, e.g., via the Internet 170, as described below with reference to FIG. 3. In one embodiment, the domain place registration web site 190 may also serve as the domain place registry web site, i.e., a business 160 may be able to both register a domain location and access domain place registry information from the same web site, thus, the domain place registry server 150 may also host the domain place registration web site 190. In another embodiment, the domain place registration web site 190 may be hosted on a different server, and store or access the domain place registration information on the domain place registry server 150. Thus the business 160 may register the business domain location through the domain place registration web site 190, then the business or a third party may access the domain place registry, retrieve domain place registry information, and develop KGL-based content for the business KGL web site 180, described in more detail below.

A customer at the business site (on premises) operating a personal computing device (PCD) 110 may communicate with one of the access points 120 to gain access to network services, such as Internet access. The PCD 110 may have a wireless communication device, e.g., a wireless Ethernet card, Bluetooth wireless interface, etc., for communicating with a wireless access point 120. In one embodiment, the PCD 110 may instead have a wired communication device, e.g., an Ethernet card, for communicating with a wired access point 120B. In other words, the PCD may connect to the network via an Ethernet port made available by the business. In one embodiment, the business may provide one or more computing devices 110 for customers to access the network.

The PCD 110 may be any of various types of devices, including a computer system, such as a portable computer, a personal digital assistant (PDA), an Internet appliance, a communications device or telephony device, such as a cellular telephone, or other wired or wireless device. The PCD may include various wireless or wired communication devices, such as a wireless Ethernet (IEEE 802.11) card, Bluetooth logic, paging logic, RF communication logic (such as cellular phone logic), a wired Ethernet card, a modem, a DSL device, an ISDN device, an ATM device, a parallel or serial port bus interface, or other type of communication device.

In one embodiment, the PCD 110 may include a memory medium which stores identification information of the user. The identification information may be a digital certificate, a System ID (an 802.11 System ID), a MAC ID of a wireless Ethernet device comprised in the PCD 110, the name of the user, or other type of information that uniquely identifies the user. Where the wireless network is IEEE 802.11 wireless Ethernet, the identification information or System ID may be a SSID (Service Set ID), an ESSID (Extended Service Set ID) or possibly a BSSID (Basic Service Set ID). Where the wireless network is Bluetooth, the identification information may be an IP address. The identification information may be contained in a digital certificate, which may be stored in a web browser or other location of the personal computing device 110.

Where the access point 120 is a wireless access point 120, the wireless communication may be accomplished in a number of ways. In one embodiment, PCD 110 and wireless AP 120 are both equipped with an appropriate transmitter and receiver compatible in power and frequency range (e.g., 2.4 GHz) to establish a wireless communication link. Wireless communication may also be accomplished through cellular, digital, or infrared communication technologies, among others. To provide user identification and/or ensure security, the PCD 110 may use any of various security mechanisms, such as WEP (Wired Equivalent Privacy).

Where the access point 120 is a wired access point 120, the wired connection may be accomplished through a variety of different ports, connectors, and transmission mediums. For example, the PCD 110 may be connected through an Ethernet, USB, serial, or parallel transmission cables, among others. The PCD 110 may also include various communication devices for connecting to the AP 120, such as wired Ethernet cards, modems, DSL adapters, ATM adapters, ISDN devices, or other communication devices. For example, a hotel may have Ethernet connections in the restaurants, shops, and guest rooms. A business, e.g., a coffee shop or bookstore, may also have both wireless and wired connections for mobile users. A user may connect to a wired access point 120 through the use of a laptop computer (PCD 110), an Ethernet network card, and a network cable. This connection may have the same functionality as a connection made to a wireless AP 120 as discussed above.

FIG. 1B—Network Communication System Without Access Points

FIG. 1B is a block diagram of another network communication system which may be suitable for implementing various embodiments of the present invention. As FIG. 1B shows, the network communication is similar to that described above with reference to FIG. 1A, but the PCD 110 is a wireless telephone 110C, such as a cellular telephone, which includes a Global Positioning System (GPS) 111. In one embodiment, the wireless telephone 110C may access the Internet 170 via a radio tower 130. The radio tower may transmit signals from the wireless telephone 110C to the public switched telephone network (PSTN) which may transmit the signals on to the Internet 170. In this embodiment, the PCD may transmit KGL information to the KGL web site, obviating the need for the AP. Further details of both embodiments of the network communication system are described below.

As discussed further below, in one embodiment, when a personal communication device 110 of a user begins communication with an access point 120, to access the KGL web site 180 through the Internet 170, for example, KGL information regarding the domain location (i.e., the business location) may be determined by the KGL web site 180. In one embodiment, the KGL information may be determined by correlating the access point (AP) 120 with stored KGL information, such as may be stored on the server 150. In other embodiments, the KGL information may be transmitted by the AP 120 or by the PCD 110 to the web site 180. The web site 180 may then use this KGL information to provide KGL based services to the customer, such as maps of the area local to the business. As another example, a customer may be presented with advertisements, including discounts or specials, for goods or services of the business, and/or of nearby businesses. In other words, businesses located in the same area may have previously used the domain place registry to identify or “find out” about each other, and then may have agreed to provide advertisements or incentives to each other's customers to encourage cross-selling or cross-advertising. Said another way, a business A may structure a deal with business B to provide offers, inducements, discounts, promotions, or other information, for business B on business A's KGL web site, in exchange for the same from business B. For example, in a coffee shop located near a book store (such as in a shopping mall), the KGL web site of the coffee shop may include a list of best-sellers and discount coupons for books, while the KGL web site of the book store may include the coffee shop's menu, or discounts on coffee shop treats. Other examples of KGL services which may be provided to an on-site customer include up to date weather reports for the area, geographic or merchant maps of the area, locations of nearby services, or any other type of information related to the business location.

In another embodiment, the personal communication device (PCD) 110 may transmit information, such as ID information, to the AP 120, and the identity of the customer may be determined using this information. In other words, a customer of the business may be identified so as to provide customer specific KGL services and/or infomediary services. The memory medium containing the data structure may be accessed, and received identification information from the respective personal computing device 110 may be used to index into the data structure or table to determine the KGL and/or the customer. For example, if a coffee shop business provided KGL services to its customers, a repeat customer who accesses the KGL web site may be identified and presented with discounts or specials related to the coffee shop products (coffee, pastries, etc.) or to the network services, such as a half-priced Internet access session or a free half-hour of Internet access. In one embodiment, the identity of the customer may be used to personalize the information and services presented to the customer on the web site. For instance, in one embodiment, if the customer has been identified as “John Doe”, with a long history of transactions stored on the registry server 150, the web site may access the customer's information and present a message like, “Welcome, John, would you like your usual order of a double latte, two scones, and a crumpet, with at 20% discount?” In one embodiment, the customer may then place his order from the web site 180. The web site 180 may transmit the order information to a terminal in the coffee shop (e.g., in the kitchen), as well as to the registry server 150, where the customer's transaction history file may be updated. Thus, KGL information may be combined with customer identity information to provide special services to customers of the business. For examples of various types of infomediary services, please see U.S. patent application Ser. No. 09/551,309 titled “System and Method for Managing User Demographic Information Using Digital Certificates”, incorporated by reference above.

It is further contemplated that time information may be used to provide special services to businesses and customers. In one embodiment, the web site 180 may present the customer with specific menus based upon the time of access. For example, in the coffee shop scenario described above, the web site may present a breakfast menu to customers accessing the web site before noon, and a lunch menu after noon. It is further contemplated that such time information may be combined with customer identity information and/or KGL information to further customize or personalize the services provided to the customer and/or business.

The domain place registry may store other information, such as a directory of all the elements (e.g., APs, PCDs, etc) in the network, the topology of the network, characteristics of individual network elements, characteristics of connection links, performance and trend statistics, and any information which is of interest in the operation of the network 170. For example, the domain place registry may store the precise longitude, latitude, altitude and other geographic information pinpointing the location of each access point.

Thus, as mentioned above, the network communication system 100 may be geographic-based. In other words, the network communication system 100 may provide information and/or services to the user (on-site customer) based at least partly on the known geographic location (KGL) of the user, e.g., as indicated by the access points 120 or as indicated by geographic information (e.g., GPS information) provided from the PCD 110. In one embodiment, the APs 120 may be arranged at known geographic locations and may provide geographic location information regarding the geographic location of the user or the PCD 110. In another embodiment, the PCD 110 may provide geographic location information of the PCD 110 through the AP 120 to the network 130. For example, the PCD 110 may include GPS (Global Positioning System) equipment 111 to enable the PCD 110 to provide its geographic location through the AP 120 to the system 100, such as to the domain place registry server 150, coupled to the network 170. In another embodiment, described above with reference to FIG. 1B, the PCD 110 may comprise a cellular telephone with GPS 111, and may transmit the KGL information to the web site 180 via the radio tower 130, removing the need for intervening APs 120.

In one embodiment, the network system 100 may provide information and/or services to the user based on both the known geographic location of the user and an access level of the user. For example, a bank official may have an access level which allows access to security codes regarding electronic or physical access to funds. The access level may only be operational when the employee (or the employee's PCD) is in a secure area of the bank, thereby preventing unauthorized or unintended access to sensitive information, such as due to coercion or theft of the user's PCD. For more information regarding KGL services and access levels, please see U.S. patent application Ser. No. 09/551,291 titled “A Distributed Network Communication System which Enables Multiple Network Providers to Use a Common Distributed Network Infrastructure”, U.S. Pat. No. 5,835,061 titled “Method and Apparatus for Geographic-Based Communications Service”, U.S. Pat. No. 5,969,678 titled “System for Hybrid Wired and Wireless Geographic-Based Communications Service”, and U.S. patent application Ser. No. 09/433,817 titled “Geographic Based Communications Service”, each of which is incorporated by reference above.

Memory Medium and Carrier Medium

One or more of the systems described above, such as PCD 110, access points 120, Domain Place Registration (DPR) servers 150, and service providers 140 may include a memory medium on which computer programs or data according to the present invention may be stored. For example, each of the access points 120 and/or the DPR server 150 may store a data structure as described above comprising information regarding domain place registration information, identification information, or KGL services information. In one embodiment, the data structure may also include a history of customer specific interactions, transactions, or offers which may be analyzed to provide further services.

The term “memory medium” is intended to include various types of memory or storage, including an installation medium, e.g., a CD-ROM, or floppy disks 104; a random access memory or computer system memory such as DRAM, SRAM, EDO RAM, Rambus RAM, EPROM, EEPROM, flash memory etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network. In the latter instance, the second computer provides the program instructions to the first computer for execution. The memory medium may also be a distributed memory medium, e.g., for security reasons, where a portion of the data is stored on one memory medium and the remaining portion of the data may be stored on a different memory medium. Also, the memory medium may be one of the networks to which the current network is coupled, e.g., a SAN (Storage Area Network).

Also, each of the computer systems described above may take various forms, including a personal computer system, mainframe computer system, workstation, network appliance, Internet appliance, personal digital assistant (PDA), television system or other device. In general, the term “computer system” can be broadly defined to encompass any device having a processor which executes instructions from a memory medium.

The memory medium in one or more of the above systems thus may store a software program or data for performing or enabling KGL services within network system 100. A CPU or processing unit in one or more of the above systems executing code and data from a memory medium comprises a means for executing the software program according to the methods or flowcharts described below.

Various embodiments further include receiving or storing instructions and/or data implemented in accordance with the present description upon a carrier medium. Suitable carrier media include memory media as described above, as well as signals such as electrical, electromagnetic, or other forms of analog or digital signals, conveyed via a communication medium such as networks and/or a wireless link.

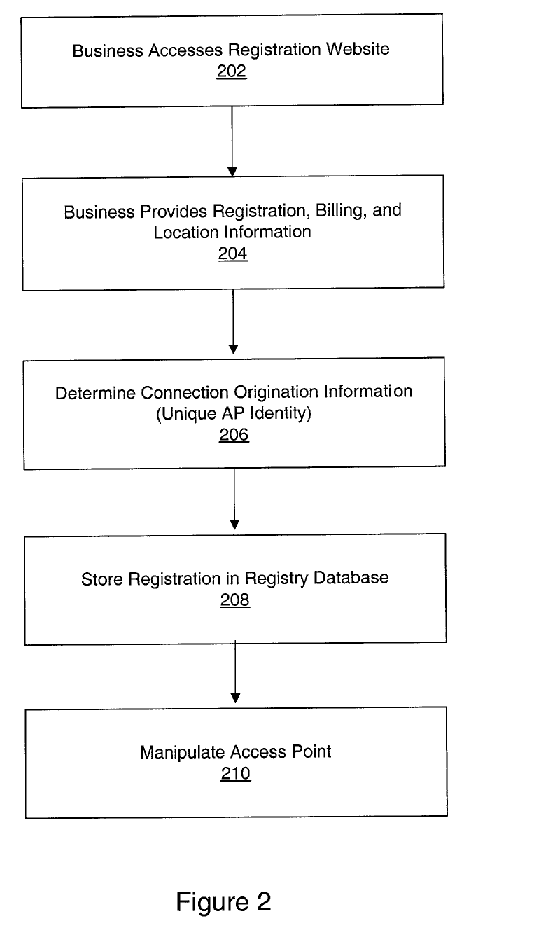

FIG. 2: Flowchart of a KGL Service Registration Process

FIG. 2 is a flowchart of the KGL service registration process, according to one embodiment. It should be noted than in various embodiments, various of the steps presented below may occur in a different order than shown, or may be omitted as desired. In other embodiments, other additional steps may be included. In the preferred embodiment, the business 160 has a network access infrastructure present on the business premises, such as a DSLAP, cable modem, etc., as well as Internet access capabilities. The business may be made aware of the possibility of KGL services through any channels of advertisement available.

As FIG. 2 shows, in 202, the business or client may access the domain place registration web site 190. Note that as used herein, the term “business” may be used to mean the business itself, the physical structure of the business, the proprietor of the business, or a representative thereof, such as a third party web site developer. Similarly, as used herein, the term “client” refers to the business, the owner of the business, or a representative thereof, e.g., a third party web site developer. Additionally, the term “web site” may refer not only to the web site, but to the server hosting the web site, as well. Note that this method of registration is used in a preferred embodiment of the invention. In other embodiments, the domain place registration may be performed via more traditional means of communication, such as by telephone, mail, in person, or by email, among others. In one embodiment, the domain place registration web site may be hosted on a server computer system. In one embodiment, the domain place registration web site may be hosted on the same server computer system as the domain place registry, i.e., the registration web site/server 190 may be the same as the domain place registry web site/server 150. In one embodiment, the domain place registration web site 190 may be hosted on the same server computer system as the KGL web sites for one or more subscribing businesses.

In 204, the client may provide registration information to the domain place registration web site/server 190. The registration information may include the business name, business proprietor, business description, billing information, such as a valid credit card number or billing address, and the location of the business. Information regarding location of the business may be provided using an address (e.g., street address, city, state, zip code, etc.), latitude and longitude, a selection made on a displayed map, or other means. In one embodiment, the registration information may also include the names and addresses or contact information for other businesses in the area. In one embodiment, the client may provide these business names as potential partners for cooperative advertisements or promotions. In one embodiment, the registration information may also include the types of advertisements, discounts, promotions, or information which the client would like presented to customers at the KGL web site 180. In one embodiment, the client may provide a URL (Uniform Resource Locator) specifying the KGL web site 180 for the business.

The business may also provide infomediary information on desired infomediary services. The infomediary services may be regarding the type, tracking, and use of various user demographic information. Example business or infomediary services include: 1) whether users should pay for Internet access; 2) what demographic information, if any, should be queried from or obtained from the user; 3) what advertisements or coupons should be provided to the user, e.g., based on demographic information, past purchases or number of visits, or other information; 4) whether each user's Internet usage should be tracked; 6) whether the user's browsing of the business website should be tracked; and/or 7) whether purchases should be tracked. These KGL and/or infomediation services may then be implemented by a server associated with the domain place registry, or a server associated with the domain place registry may use this information to automatically configure the business web site accordingly. Businesses may thus use the domain place registry to specify or implement infomediary services, such as tracking user demographic information, including purchasing habits, frequency of visits, memberships, etc. and use this information to provide more personalized services to customers.

In one embodiment, the domain place registration server 190 may provide an online form to the client with which to enter the registration information. In an alternate embodiment, the server software may include a registration wizard which leads the client through the registration process, collecting the information entered by the client in response to questions or requests. The online form or registration wizard may include a map that is displayed, wherein the user can zoom in on the map and select the geographic location of the business graphically, e.g., by selecting or clicking on a location of the map.

In 206, the system may determine connection origination information, such as a unique AP identity associated with the client's AP 120. In one embodiment, the IP (Internet Protocol) address of the client may be determined by the server 190. The server 190 may then determine whether the connecting device (used by the client) is a router in front of an AP, a DSLAP, or some other common network device configuration. The server 190 may then advise the client whether it is or is not feasible to automatically redirect customer data traffic to a provided KGL web site 180, or whether to instead have the customer directly enter the URL of the KGL web site 180 to access KGL services. In one embodiment, the system may determine the KGL of the business from the unique AP identity, such as from a lookup table. In another embodiment, the AP 120 may store its KGL information and may transmit the AP's KGL to the system.

In 208, the system may generate a domain place registry entry in response to receiving the client registration information of 204, i.e., the registration information may be stored in a domain place registry database. In one embodiment, the domain place registration web site 190 may be operable to provide domain place registry information to registered users who access the web site, such as information regarding business locations, names, categories, etc., for use in providing KGL services.

Finally, in 210, the system may manipulate the access point 120 to facilitate the provision of KGL services to customers of the business. For example, in one embodiment, the AP 120 may be re-configured to store the URL of the business's KGL web site 180. In other words, the system or server may download a small subprogram or applet to the AP 120 that reconfigures the AP 120 to first access the KGL web site 180. Then, when an on-site customer accesses the Internet 170 and loads a URL for a target web site, the AP 120 may redirect the customer first to the KGL web site 180. In one embodiment, the redirection may simply involve overlaying the KGL web site 180 over the target web site, such that by clicking an “ok” button, the KGL web site 180 disappears, revealing the original target web site. In another embodiment, the system may store the URL of the target web site, present the KGL web site 180, then, once the customer has dismissed the KGL web site, display the target web site.

In step 210 the system may also configure software to enable the KGL and/or infomediation services requested by the user. The web site which implements the KGL and/or infomediation services may operate at the premises of the domain place registry, may operate at a third party site, or the web site of the business may be automatically or manually configured to provided these services. In one embodiment, the domain place registry server may use the configuration selections of the user to download or configure software on a server of the business (the business web site) to enable the business web site to offer these services.

In one embodiment, the system may charge a registration or subscription fee to the business upon completing the registration process.

FIG. 3: Flowchart of a Method for Business Use of the Domain Place Registry

FIG. 3 is a flowchart of a method for business use of the domain place registry, according to one embodiment. It should be noted than in various embodiments, some or all of the steps describes may be performed in a different order than shown, or may be omitted, as desired. Additionally, other additional steps not shown may be performed. It should also be noted that any of the following steps may be performed by the business 160 or by a third party operating for or representing the business, such as a third party web site or web content developer.

As FIG. 3 shows, in 302, the domain place registry may be accessed by a client, for example, by the business 160, or by a third party acting on the part of the business, such as a web site designer/content provider. In the preferred embodiment, some kind of registered user authentication may be required to gain access to registry information, such as a user name and password.

In 304, in response to the access of 302, the system may display domain place registry information. For example, the displayed domain place registry information may include information of registered businesses in a particular area, such as business names, the locations of the businesses, business proprietors, business descriptions, contact information, etc. In one embodiment, the information may be displayed in response to queries entered by the client. In other embodiments, the client may select information to be displayed via menus, wizards, panels, or any other interface device or method. For example, in one embodiment, the client may enter a desired location, such as an address, as well as a radius for the area of interest. The client may also select an area on a displayed map, e.g., zoom in to the correction location on the map and mark, e.g., click on, or draw a circle or box around, the geographic location of the business. The system may then return or display selected information regarding businesses within the radius of the entered location. For example, the client may request a list of book stores within a kilometer of the business location. In the case of a competitive business analysis for a coffee shop, the client may request a list of all the coffee shops within some radius in the area. The system may return the information in various forms, including text and graphics. For example, in addition to the lists mentioned, the system may display maps of the area showing relative locations of the businesses. In one embodiment, the system may provide other information related to the area of interest, such as locations of parks, or other locations of interest, in the form of text or maps. In one embodiment, the system may provide various data manipulation and analysis tools, such as sorting businesses by distance from the selected or entered location.

In one embodiment, the domain place registry information for a business may include indications as to whether the business is amenable to cooperative or cross advertising and cross selling with other businesses in the area. The domain place registry information for the business may also include the URL of the business's KGL web site, so that interested parties accessing the registry may investigate the nature and style of prospective partners' web sites. In one embodiment, domain place registry information for the business may also include examples of advertisements, coupons, discounts, or other information which the business would like displayed on partner's web sites.

In 306, the client may contact neighboring businesses based on the retrieved domain place registry information of 304 and structure cooperative deals for cross advertising and/or cross selling. For example, as mentioned above, the coffee shop proprietor may arrange a deal with the nearby book store such that the coffee shop KGL web site provides information and/or discounts for books, magazines, or other items in the book store, in exchange for presentation of the coffee shop menu and discounts for coffee shop treats on the book store's KGL web site.

Finally, in 308, the business, or a third party operating on behalf of the business 160, may create KGL based content for the business's KGL web site 180 using the domain place registry information of 304. In other words, information stored in the domain place registry may be used to develop the KGL web site 180 for the client or business. As noted above, the KGL web site content may include advertising or other information of the registered business as well as information of neighboring registered businesses. In the preferred embodiment, the KGL web site 180 is accessible over the network 170, e.g., over the Internet 170, by on-site customers of the business 160. The KGL web site may include information and services related to the business, such as online catalogues, menus, promotions, advertisements, etc., as well as KGL services, which may include maps of the area local to the business, local weather information, the names, locations, or contact information of surrounding businesses that are registered in the registry, and advertisements and/or services of neighboring businesses, among others.

In the embodiment wherein time information is used with KGL services, a business's KGL web site 180 may provide cross information only for nearby business which are currently open for business. For example, if business A stays open twenty-four hours per day, business B is open from nine in the morning until five in the afternoon, and business C is open from three in the afternoon until midnight, and if business A has cooperative agreements with B and C for cross advertising, the system may present different information on A's KGL web site depending upon the time of day. In other words, a customer on business A's premises accessing A's KGL web site may be presented with business B's advertisements or discounts from nine until five, and business C's advertisements or discounts from three until midnight. In other embodiment, as mentioned above, the KGL web site 180 may provide different web site content based upon time information, such as different menus for different times of the day. The web site content may also be based on other information, such as supply chain information, e.g., information regarding product inventory that must be sold.

In one embodiment, the system may charge an access fee to a business for each access of the registry by the business. In another embodiment, the subscription fee mentioned above with reference to FIG. 2 may grant a registered business a number of free accesses to the registry. In yet another embodiment, the subscription fee may grant a registered business unlimited access to the registry. In a further embodiment, the system may allow different subscription levels corresponding to different levels of KGL services and/or access.

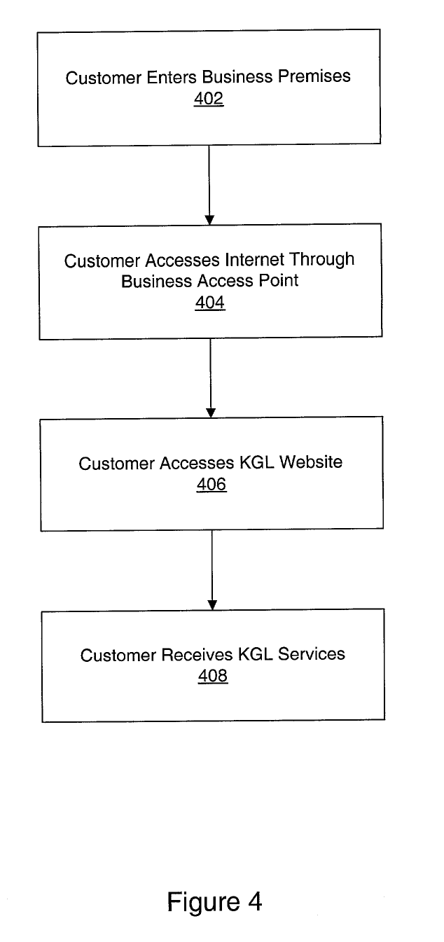

FIG. 4: Flowchart of a Method for Providing KGL Services

FIG. 4 is a flowchart of a process for providing KGL services using the network system of FIG. 1A or FIG. 1B, according to one embodiment. It should be noted that in various embodiments, various of the steps presented below may occur in a different order than shown, or may be omitted, as desired. In other embodiments, additional steps may be included, as well.

As FIG. 4 shows, in 402 a customer of the business 160 may enter the business premises 160. As mentioned above, in the preferred embodiment, the business 160 provides wireless or wired network access via one or more access points 120. Alternatively, the business may not provide any network access, and the customer may access the Internet through a wireless device that does not require an AP, e.g., a cell phone that communicates with a nearby cell tower. In this case, the wireless device may provide GPS information indicating the user's location.

In 404, the customer of the business 160 may access the network 170, e.g., the Internet 170, through one of the business access points (AP) 120 located on-site. For example, in the coffee shop mentioned above, a customer enjoying a cup of coffee and a snack may decide to conduct some personal business over the Internet. For illustration purposes, it is assumed that the customer uses a wireless PCD 110A to connect through the business AP 120 to the Internet 170. In other embodiments, as mentioned above, the customer may access the Internet 170 via a cellular telephone, obviating the access point 120. As mentioned above, in various embodiments, the network access may be provided for free, for a flat rate, or based upon services or access used by the customer.

Once the customer has network access, then in 406, the customer may access the KGL web site 180. In the preferred embodiment, the business 160 may maintain a business web site, or “home page”, which customers may access for information, sales, or service related to the business. In one embodiment, the KGL web site 180 may be the home page of the business 160. In another embodiment, the KGL web site 180 may be accessed through a link on the business's home page web site. In yet another embodiment, customer communications (web navigation) may be automatically re-routed to the KGL web site 180, such as by special circuitry or program instructions comprised in the AP 120, or by other means. This re-routing of the customer's web navigation may be referred to as forced first page (FFP). In one embodiment, the URL of the KGL web site 180 may be stored on the AP 120, and the AP 120 may simply intercept the initial URL request of the customer and substitute the KGL URL for the original URL. In one embodiment, the FFP may result in the KGL web site 180 being overlayed on the original web page requested by the customer. In one embodiment, the customer may simply click an “OK” button on the KGL web site 180 to remove or dismiss the KGL web site 180, thereby revealing the original web page. In another embodiment, the customer may enter a specific URL into his web browser, e.g., www.wayport.net, to access the KGL web site. The customer may be motivated to do this by posted information regarding the availability of discounts at the web site 180. For example, in this embodiment, when the customer accesses the site (www.wayport.net), server software executing on the corresponding web server may determine (from the AP identity and registry information) the location of the customer, and forward the customer to that business's KGL web site 180.

As mentioned above, in various embodiments, KGL information of the business or customer may be determined by the system, such as by transmission of the KGL by the AP 120, transmission of GPS information by the customer's PCD 110, or by transmission of an identifying ID, such as a MAC ID, of the AP 120, which the system may use to look up the KGL information from a database. In other embodiments, the PCD 110 may transmit an ID uniquely identifying the PCD 110 to the system, which the system may use to determine the identity of the customer from a look-up table or database. In another embodiment, the system may determine the time of access, and use this time to provide time based KGL services to the customer, as described below.

Finally, in 408, the customer may receive KGL services and/or infomediary services in response to accessing the KGL web site 180. As mentioned above, the KGL services provided to the customer on the KGL web site 180 may include information such as advertisements, promotions, discounts, or other information specific to the location of the business. For example, the customer of the coffee shop may be presented with an electronic coupon (with a unique ID number) good for one or more treats, discounts, free or reduced fee Internet access, or other discounts or incentives useable at the business location. In another embodiment, the customer may receive information, advertisements, promotions, or discounts related to other shops or businesses in the area. Thus, various business in the same area may provide cooperative advertisements or promotions on each other's respective KGL web sites.

The infomediary services provided to the customer on the KGL web site 180 may include services particular to the customer or the demographic information of the customer, such as personalized offers, targeted advertising, offers based on frequency of past visits or past purchases, and other services based on user demographic information.

As mentioned above, in one embodiment, the customer may receive additional KGL services beyond the advertisements and discounts related to the businesses of the area. For example, the customer may receive information regarding the present or predicted weather for the area, or maps of the area indicating items of interest, such as museums, parks, festivals, or other locations or events of interest. As also mentioned above, the customer may be identified by the system and presented with personalized information, such as rewards for repeat business, or personalized messages or services based upon past history. In the embodiment where time information is used by the system to manage KGL services, the customer may receive time-of-day based KGL services, such as particular menus in a restaurant or coffee shop (e.g., breakfast menus and specials vs. dinner menus and specials).

In other embodiments of the invention, the KGL services may include functions to aid internal operations of a business. For example, as mentioned above, a bank official may have an access level which allows access to security codes regarding electronic or physical access to funds. The access level may only be operational when the employee (or the employee's PCD) is in a secure area of the bank, such as a vault area, thereby preventing unauthorized or unintended access to sensitive information or materials, such as due to coercion or theft of the employee's PCD. In another embodiment, the KGL services may be provided to employees of an airline such that when an employee is in the ticketing area, the employee's access level may include access to ticketing information.

Thus, the method described above allows a business or establishment to provide location dependent services to on-site customers through a network system, such as the Internet.

While the present invention has been described with reference to particular embodiments, it will be understood that the embodiments are illustrative and that the invention scope is not so limited. Any variations, modifications, additions, and improvements to the embodiments described are possible. These variations, modifications, additions, and improvements may fall within the scope of the inventions as detailed within the following claims.

What is claimed is:

1. A method for creating geographic based content in a network system, the method comprising:
receiving business registration information of a business, wherein the business registration information includes location information of the business; and
registering a domain location of the business in a registry in response to said receiving business registration information;
wherein the registry is useable in creating geographic based web site content for one or more businesses.

2. The method of claim 1, further comprising:
the business accessing the registry to determine one or more neighboring businesses which are present in the registry; and
generating web site content for the business, wherein the web site content includes one or more references to the one or more neighboring businesses which are present in the registry.

3. The method of claim 2,
wherein the business accessing the registry to determine one or more neighboring businesses which are present in the registry comprises:
displaying a map which shows the location of the business and locations of the one or more neighboring businesses which are present in the registry.

4. The method of claim 3, further comprising:
the business contacting at least one of the one or more neighboring businesses which are present in the registry to structure a cooperative deal to cross sell or cross advertise on a web site of the business and on a web site of the at least one of the one or more neighboring businesses, respectively.

5. The method of claim 1,
wherein the web site content is comprised on a web site of the business;
wherein the business includes an access point for accessing the web site;
the method further comprising:
a customer accessing the web site through the access point;
the customer accessing known geographic location (KGL) services from the web site; and
providing KGL services to the customer through the web site.

6. The method of claim 5, wherein the KGL services comprise one or more of discounts, coupons, specials, and promotional offers for products or services of the business or one or more neighboring business.

7. The method of claim 5, wherein the KGL services comprise weather information for an area local to the business.

8. The method of claim 5, wherein the providing KGL services to the customer through the web site comprises:
determining a time-of-day for said customer accessing; and
providing time based KGL services to the customer through the web site, wherein said time based KGL services comprise presenting different web site content depending on the determined time-of-day.

9. The method of claim 5, wherein the KGL services comprise a map showing the locations of one or more of:
merchants in an area local to the business;
parks or museums in the area local to the business; and
festivals or events in the area local to the business.

10. The method of claim 5,
wherein the customer is an employee of the business;
wherein the customer accessing the web site through the access point comprises the employee accessing the web site through the access point via a personal computing device (PCD);
the method further comprising:
the access point transmitting KGL information to the web site;
the PCD transmitting ID information to the web site through the access point; and
the web site determining an identity of the employee in response to said transmitting; and
granting the employee a network access level based upon the identity of the employee and the KGL information in response to said determining.

11. The method of claim 5, wherein the customer accessing the web site through the access point comprises:
the customer requesting access to a target web site, wherein the access request includes network address information of the target web site;
the access point receiving the access request from the customer; and
the access point redirecting the access request to the web site in response to receiving the access request.

12. The method of claim 11, further comprising:
the customer exiting the web site; and
presenting the target web site to the customer in response to said exiting.

13. The method of claim 5, the method further comprising:
determining a KGL of the business after said accessing the web site and prior to said accessing KGL services, wherein said determined KGL of the business is useable to provide said KGL services to the customer.

14. The method of claim 13, wherein the determining a KGL of the business comprises one or more of:
receiving the KGL of the business from the access point, wherein the KGL of the business is stored in the access point;
receiving a unique ID from the access point, and looking up the KGL of the business in a database; and
receiving the KGL of the business from the customer, via a personal computing device, wherein the personal computing device includes a GPS unit operable to provide KGL information.

15. The method of claim 5,
wherein the customer accessing the web site through the access point comprises the customer accessing the web site through the access point via a personal computing device (PCD);
the method further comprising:
the PCD transmitting ID information to the web site; and
the web site determining an identity of the customer in response to said transmitting; and
wherein said providing KGL services to the customer through the web site comprises providing personalized KGL services to the customer through the web site in response to said determining the identity of the customer.

16. The method of claim 1, wherein the web site content is comprised on a business web site, the method further comprising:
a customer accessing the web site via a wireless telephone, wherein the wireless telephone includes a GPS unit;
the wireless telephone transmitting KGL information to the web site;
the customer accessing KGL services from the web site; and
providing KGL services to the customer through the web site.

17. The method of claim 16, further comprising:
the wireless telephone transmitting ID information to the web site;
the web site determining an identity of the customer in response to said transmitting; and
providing personalized KGL services to the customer through the web site in response to said determining the identity of the customer.

18. The method of claim 1, wherein said receiving business registration information comprises:
the business accessing a registration web site; and
the business providing the business registration information.

19. The method of claim 1, wherein said receiving business registration information comprises:
the business providing the business registration information via one or more of mail, email, telephone, or personal conveyance.

20. The method of claim 1, further comprising:
charging a subscription fee to the business in response to said registering;
wherein payment of said fee grants the business a number of free accesses to the registry; and
wherein an access fee is charged for each access by the business in excess of said number.

21. A system for creating geographic based content, wherein the system includes:
a memory medium which stores a registry comprising a plurality of domain locations of a plurality of businesses;
wherein the registry is useable in creating geographic based web content for one or more businesses.

22. The system of claim 21,
wherein the registry is useable in determining one or more neighboring businesses which are present in the registry; and
wherein web site content is operable to be generated for a first business, wherein the web site content includes one or more references to one or more neighboring businesses of the first business which are present in the registry.

23. The system of claim 22, further comprising:
a registration web site hosted on a registration server;
wherein the registration web site is accessible by a business;
wherein the registration web site is operable to receive business registration information from the business, including location information of the business; and
wherein the registration web site is operable to register a domain location of the business in the registry in response to said receiving business registration information.

24. The system of claim 22, further comprising:
a domain place registry server which is operable to host the registry; and
a registry web site whereby the registry is accessible by a registered business;

25. The system of claim 22, further comprising:
a domain place registry server which is operable to host each of the registry, a registration web site, and a registry web site;
wherein the registration web site is accessible by a business, and is operable to receive business registration information from the business, including location information of the business;
wherein the registration web site is further operable to register a domain location of the business in the registry in response to said receiving business registration information; and
wherein the registry is accessible through the registry web site by a registered business.

26. The system of claim 22,
wherein the registry is operable to provide domain location information to registered businesses accessing the registry; and
wherein the domain location information comprises a map which shows the location of one or more businesses in an area which are present in the registry.

27. The system of claim 22,
wherein the one or more neighboring businesses comprise a second business;
wherein said web site content includes one or more references to the second business; and
wherein second web site content is operable to be generated for the second business, wherein the second web site content includes one or more references to the first business.

28. The system of claim 21,
wherein the registry is operable to receive one or more queries from a registered business accessing the registry;
wherein the registry is operable to provide domain location information of at least a subset of the plurality of businesses to the registered business in response to said one or more queries; and
wherein the provided domain location information comprises one or more subsets of domain location information comprised in the registry corresponding respectively to said one or more queries.

29. The system of claim 28, wherein said domain location information for a business comprises one or more of:
a name of the business;
a location of the business;
a domain name of the business;
an owner of the business;
contact information of the business;
a URL of a web site of the business;
a description of the business; and
a description of cooperative agreements desired by the business.

30. A system for creating geographic based content, wherein the system includes:
a memory medium which stores a registry comprising a plurality of domain location entries, wherein each domain location entry comprises a domain name of a business and a geographic location of the businesses;
wherein the registry is useable in creating geographic based web content for one or more businesses.

31. A network system for providing known geographic location (KGL) services, comprising:
a network;
at least one access point coupled to the network; and
a memory medium which stores a registry comprising a plurality of domain location entries, wherein each domain location entry comprises a domain name of a business and a geographic location of the business;
wherein the registry is accessible through the network via the at least one access point, and wherein the registry is useable in creating geographic based web content for one or more businesses.

32. The network system of claim 31,
wherein the registry is useable in determining one or more neighboring businesses of a first business which are present in the registry; and
wherein web site content is operable to be generated for the first business, wherein the web site content includes one or more references to the one or more neighboring businesses which are present in the registry.

33. The network system of claim 31,
wherein the at least one access point is operable to communicate with a personal computing device; and
wherein the at least one access point is configured to receive identification information from the personal computing device.

34. The network system of claim 33,
wherein the at least one access point is located at a first business;
wherein the personal computing device is operated by a customer located at the first business;
wherein the received identification information comprises KGL information;
wherein the web site content is comprised on a web site of the first business;
wherein the web site is accessible to the customer through the at least one access point;
wherein the at least one access point is configured to transmit the KGL information to the web site; and
wherein the web site is operable to provide KGL services to the customer based upon the web site content and the KGL information.

35. The network system of claim 34, wherein the KGL services comprise one or more of discounts, coupons, specials, and promotional offers for products or services of the business or one or more neighboring business.

36. The network system of claim 34, wherein the KGL services comprise weather information for an area local to the business.

37. The method of claim 34,
wherein the web site is operable to determine a time-of-day for an access of the web site by the customer, and provide time based KGL services to the customer, wherein said time based KGL services comprise presenting different web site content depending on the determined time-of-day.

38. The method of claim 34, wherein the KGL services comprise a map showing the locations of one or more of:
merchants in an area local to the business;
parks or museums in the area local to the business; and
festivals or events in the area local to the business.

39. The network system of claim 33,
wherein the at least one access point is located at a first business;
wherein the personal computing device is operated by a customer located at the first business;
wherein the web site content is comprised on a web site of the first business;
wherein the web site is accessible to the customer through the at least one access point;
wherein the at least one access point is configured to transmit KGL information to the web site;
wherein the web site is operable to determine a KGL of the business in response to said transmittal of the KGL information; and
wherein the web site is operable to provide KGL services to the customer based upon the web site content and the determined KGL of the business.

40. The network system of claim 39,
wherein the KGL information comprises the KGL of the business; and
wherein the KGL of the business is stored in the access point.

41. The network system of claim 39,
wherein the KGL information comprises a unique ID from the access point; and
wherein the web site is operable to receive the unique ID from the access point, and look up the KGL of the business in a database.

42. The network system of claim 39,
wherein the personal computing device includes a GPS unit operable to provide KGL information; and
wherein the identification information comprises the KGL information provided by the GPS unit.

43. The network system of claim 33,
wherein the at least one access point is located at a first business;
wherein the personal computing device is operated by a customer located at the first business;
wherein the received identification information comprises a unique ID of the personal computing device;
wherein the web site content is comprised on a web site of the first business;
wherein the web site is accessible to the customer through the at least one access point;
wherein the at least one access point is configured to transmit the unique ID to the web site;
wherein the web site is operable to determine a customer identity in response to said transmittal; and
wherein the web site is operable to provide personalized KGL services to the customer based upon the web site content and the determined customer identity.

44. The network system of claim 33,
wherein the at least one access point is located at a first business;
wherein the personal computing device is operated by an employee of the first business;
wherein the received identification information comprises a unique ID of the personal computing device and KGL information;
wherein the web site content is comprised on a web site of the first business;
wherein the web site is accessible to the customer through the at least one access point;
wherein the at least one access point is configured to transmit the unique ID and the KGL information to the web site;
wherein the web site is operable to determine an employee identity in response to said transmittal; and
wherein the web site is operable to grant the employee a network access level based upon the KGL information and the determined identity of the employee in response to said determining.

45. The network system of claim 33,
wherein the at least one access point is located at a first business;
wherein the personal computing device is operated by a customer located at the first business;
wherein the web site content is comprised on a web site of the first business which is accessible to the customer through the at least one access point; and
wherein, in response to the customer requesting access to a target web site, the access point is operable to redirect the access request to the web site.

46. The network system of claim 45,
wherein, in response to the customer exiting the web site, the access point is further operable to present the target web site to the customer.

47. The network system of claim 31, further comprising:
a registration web site which is accessible by a business, and which is operable to receive business registration information from the business;
wherein the registration web site is operable to register the business in the registry.

48. The network system of claim 31, further comprising:
a memory medium which stores a registration system which is operable to receive business registration information from the business;
wherein the business provides the business registration information via one or more of mail, email, telephone, or personal conveyance.

49. The network system of claim 48, wherein said business registration information comprises one or more of:
a name of the business;
a location of the business;
a domain name of the business;
an owner of the business;
contact information of the business;
a URL of a web site of the business;
a description of the business; and
a description of cooperative agreements desired by the business.

50. The network system of claim 31,
wherein the system is operable to charge a subscription fee to the business in response to registering the business in the registry;
wherein payment of said fee grants the business a number of free accesses to the registry; and
wherein an access fee is charged for each access by the business in excess of said number.

51. A method for providing known geographic location (KGL) services in a network system, wherein the network system includes an access point coupled to a network, the method comprising:
receiving business registration information;
registering a domain location in a registry in response to said receiving business registration information;
generating a KGL web site for a business using information from the registry;
a customer accessing the network through the access point;
the customer accessing the KGL web site through the access point; and
providing KGL services to the customer through the KGL web site.

52. The method of claim 51, wherein said registering a domain location comprises:
the business accessing a registration web site;
receiving registration, billing, and location information from the business; and
generating the KGL web site based on the registry.

53. The method of claim 51, further comprising:
charging the business a registration fee; and
charging the business a recurring subscription fee for providing KGL services to customers of the business.

54. The method of claim 51, wherein said KGL services comprise one or more of a discount, promotion, and advertisement for a product or service of the business.

55. The method of claim 51, wherein said KGL services comprise a map which shows the location of the business and locations of one or more neighboring businesses which are present in the registry.

56. The method of claim 51, wherein the KGL services comprise weather information for an area local to the business.

57. The method of claim 51, wherein the KGL services to the customer through the KGL web site comprises:
determining a time-of-day for said customer accessing; and
providing time based KGL services to the customer through the KGL web site, wherein said time based KGL services comprise presenting different web site content depending on the determined time-of-day.

58. The method of claim 51, wherein the KGL services comprise a map showing the locations of one or more of:
merchants in an area local to the business;
parks or museums in the area local to the business; and
festivals or events in the area local to the business.

59. The method of claim 51, wherein the customer accessing the web site through the access point comprises:
the customer requesting access to a target web site, wherein the access request includes network address information of the target web site;
the access point receiving the access request from the customer; and
the access point redirecting the access request to the web site in response to receiving the access request.

60. The method of claim 59, further comprising:
the customer exiting the web site; and
presenting the target web site to the customer in response to said exiting.

61. A method for creating geographic based content in a network system, the method comprising:
receiving business registration information of a business, wherein the business registration information includes location information of the business; and
registering a domain location of the business in a registry in response to said receiving business registration information;
wherein the registry is useable in creating geographic based web site content for the business and infomediary services to be provided by the business.

62. The method of claim 61,
wherein the business registration information includes information regarding desired infomediary services.
